(19) United States
(12) Patent Application Publication
(10) Pub. No.: US 2015/0084309 A1
(43) Pub. Date: Mar. 26, 2015

(54) WORK VEHICLE CHASSIS ARTICULATION JOINT

(71) Applicant: Deere & Company, Moline, IL (US)

(72) Inventors: Brandon J. Kuboushek, Dubuque, IA (US); Steven T. Blasen, Peosta, IA (US); Gary Ralph Fichtinger, Hazel Green, WI (US)

(73) Assignee: Deere & Company, Moline, IL (US)

(21) Appl. No.: 14/033,027

(22) Filed: Sep. 20, 2013

(51) Int. Cl. B62D 12/00; B60D 99/00

(52) U.S. Cl. CPC B62D 12/00; B60D 7/00
USPC 280/400

(57) ABSTRACT

An articulated chassis work vehicle has an articulation joint rotatably coupling separate engine and equipment frames of the vehicle chassis. The articulation joint can have upper and lower joint assemblies. One or both of the upper and lower joint assemblies are constructed and arranged so that a corresponding bearing assembly is located between a single tab-like lug of each frame. In one arrangement, the articulation joint does away with clevis connections at both the upper and lower joint assemblies such that the available space within the articulation joint defined between the innermost upper and lower lugs is not reduced by additional lug and bearing components of either joint assembly.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to articulation joints for articulated heavy duty work vehicles.

### BACKGROUND OF THE DISCLOSURE

Many types of construction and forestry machines and other work vehicles have wide chasses and wheelbases, and consequently tend to track in a straight-ahead direction. To improve the cornering and turning capabilities of such large-bodied vehicles the chasses can be constructed with an articulation joint between separate front and rear frame sections. Typically, these articulated work vehicles include an engine frame that carries a prime mover, typically a gasoline or diesel engine, and an equipment frame that carries a task specific implement. The articulation joint connects the equipment frame to the engine frame and permits relative rotation of the chassis frames on the order of 90 degrees, such as 45 degrees to either side of the chassis centerline.

FIG. 1 illustrates an example articulation joint of the type commonly used in articulated work vehicles. FIG. 1 shows a typical clevis-type connection 20 that connects an equipment frame 24 to an engine frame 28. The clevis-type connection 20 includes an equipment frame clevis structure 32 rigidly connected to an upper surface of the equipment frame 24 and an engine frame tab structure 36 rigidly connected to an upper surface of the equipment frame 28. The engine frame tab structure 36 is straddled by the equipment frame clevis structure 32 and maintained therein by a pin 40. A bearing 44 is arranged to enable rotation of the equipment frame 24 relative to the engine frame 28 about the pin 40. A second clevis-type connection 48 is arranged at the bottom of the equipment frame 24 and engine frame 28. The second clevis-type connection 48 cab be similar to the clevis-type connection 20 or can have a single or multiple ball bushing arrangement. The two clevis-type connections 20 and 48 cooperate to provide an articulating joint between the equipment frame 24 and the engine frame 28.

Prior articulation joints of this type suffer from a number of shortcomings. For one thing, the prior art articulation joints are generally complex and costly to manufacturing due to the number of components involved. Clevis-type joints of this kind also can significantly affect the construction of the work vehicle in other aspects. For example, the articulation joint must be sufficiently robust to connect the large frame components of the chassis together and withstand the heavy loading of the machine components as well as impact loading realized during operation. It must also be located along the centerline of the chassis. Consequently, the articulation joint can interfere with the placement of drive shafts, and electrical or plumbing lines that extend between the engine and the work implement or other components carried by the engine and equipment frames. The double clevis-type connections of prior art articulation joints, such as shown in FIG. 1, are bulky and can significantly reduce the useable volume of space within the joint through which shafts and lines can be routed. Often such interconnecting components must be routed around the joint, which is less than optimal placement, can impede articulation, and leaves the lines vulnerable to damage or pinching as the chassis is articulated, or due to debris.

Other important considerations for large work vehicles of this type are ground clearance and overall vehicle height. It is often very important for the operation of these work vehicles to have high ground clearance in order to perform as needed on off-road terrain. High ground clearance is particularly important for forestry machines, such as skidders and the like, which are often required to drive over stumps and logs during operation. At the same time, over the road hauling of these work vehicles may require the overall height of the vehicles to be under a prescribed or regulated maximum height. Thus, in light of these considerations it may not be practical, or even possible, to position and size the articulation joint as needed to accommodate the interconnecting components within and through the joint while also meeting the overall height and ground clearance requirements of the vehicle. For example, simply enlarging the joint, such as by increasing the vertical spacing between the upper and lower connections, could reduce ground clearance or raise the overall height of the vehicle, or both. Furthermore, if the resulting height of the vehicle is raised, it can also have adverse affects on vehicle stability and operator access to the vehicle cabin.

An improved articulation joint for work vehicles is thus needed.

### SUMMARY OF THE DISCLOSURE

This disclosure addresses the aforementioned issues common in many articulated chassis work vehicles by reducing or avoiding clevis-connections in the articulation joint. One or both of the upper and lower joint assemblies of the articulation joint are constructed of a single lug or tab-like structure extending from each frame. Thus, the articulation joint is less complex and the space available within the articulation joint between the upper and lower joint assemblies is not reduced by more lug and bearing components than needed.

More specifically, one aspect of this disclosure pertains to an articulation joint for a work vehicle having a chassis including a first frame coupled to a second frame by the articulation joint. Each frame can include two spaced apart single lugs that mate with corresponding lugs of the other frame. The articulation joint can be formed by two joint assemblies spaced apart along a pivot axis. A first joint assembly can include a first bearing assembly coupled between mating first lugs of the two frames. A second joint assembly can include a second bearing assembly coupled between the second lugs of the two frames.

In one arrangement, the first frame first lug is positioned at a side of the first joint assembly opposite the second joint assembly, such that the space within the articulation joint defined between the second frame first lug and the second joint assembly is uninterrupted by the first joint assembly. In another arrangement, the first frame second lug is positioned at a side of the second joint assembly opposite the first joint assembly such that the space within the articulation joint defined between the second frame second lug and the first joint assembly is uninterrupted by the second joint assembly. In yet another arrangement, the first frame second lug is positioned at a side of the second joint assembly nearest the first joint assembly, such that the space within the articulation joint defined between the first frame second lug and the first joint assembly is uninterrupted by the second joint assembly. These arrangements thus define example articulation joints in which at least one joint assembly is formed of by mating single lugs from each frame, as well as both joint assemblies being formed by mating single lugs, either with the two lugs of one frame being to the outside of the lugs of the other frame or by interleaving the lugs the two frames.

Another aspect of this disclosure provides an example construction of the individual joint assemblies of the articulation joint. In particular, a joint assembly can include a pin having a bearing portion and that is received in and fastened to a frame lug aperture. The bearing portion of the pin can engage a bearing cone defining a cone raceway. A second frame lug aperture can receive a bearing cup defining a cup raceway. A plurality of rollers can be arranged between the cone raceway and the cup raceway. The pin can be configured to extend into but not through the second frame lug aperture. Further, the articulation joint can have an upper joint with an upper bearing assembly and a lower joint having a lower bearing assembly. Each upper and lower bearing can be of the like construction.

Another aspect of the disclosure provides an articulated chassis work vehicle. The work vehicle can have an engine frame that carries the prime mover of the vehicle and an equipment frame that carries the functional implement of the machine. An articulation joint as described above rotationally couples the engine frame to the equipment frame.

Additional aspects and advantages of the disclosure can be found in the description and drawings referenced below.

### BRIEF DESCRIPTION OF THE DRAWINGS

FIG. 1 is a partial side elevational view of a prior art articulation joint.

FIG. 2 is a side elevational view of a work vehicle including an articulation joint according to one construction of this disclosure.

FIG. 3 is a top view of the chassis of the vehicle of FIG. 2.

FIG. 4 is a partial perspective view showing the articulation joint according to the example construction of this disclosure connecting engine and equipment frames of the work vehicle chassis.

FIG. 5 is a partial perspective view thereof with portions of the engine frame removed.

FIG. 6 is a detailed perspective view of the articulation joint as taken from arc 6-6 of FIG. 4.

FIG. 7 is another partial perspective view of the example articulation joint.

FIG. 8 is an enlarged partial sectional view of the example articulation joint taken along line 8-8 in FIG. 7.

FIGS. 9 is an enlarged detail views of the example articulation joint taken within the bounds of arc 9-9 in FIG. 8.

FIG. 10 is an enlarged detail view of the example articulation joint taken within the bounds of line 10-10 in FIG. 9.

FIG. 11 is an enlarged partial perspective view showing shims of the example articulation joint.

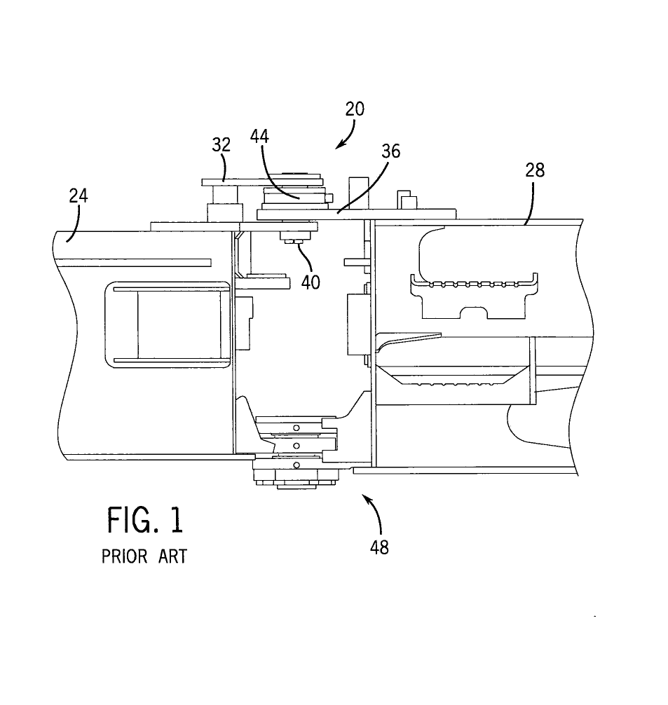

### DETAILED DESCRIPTION

As shown in the accompanying figures of the drawings described above, the following describes one or more example constructions of an articulation joint for an articulated chassis work vehicle. Various modifications to the example construction(s) may be contemplated by one of skill in the art.

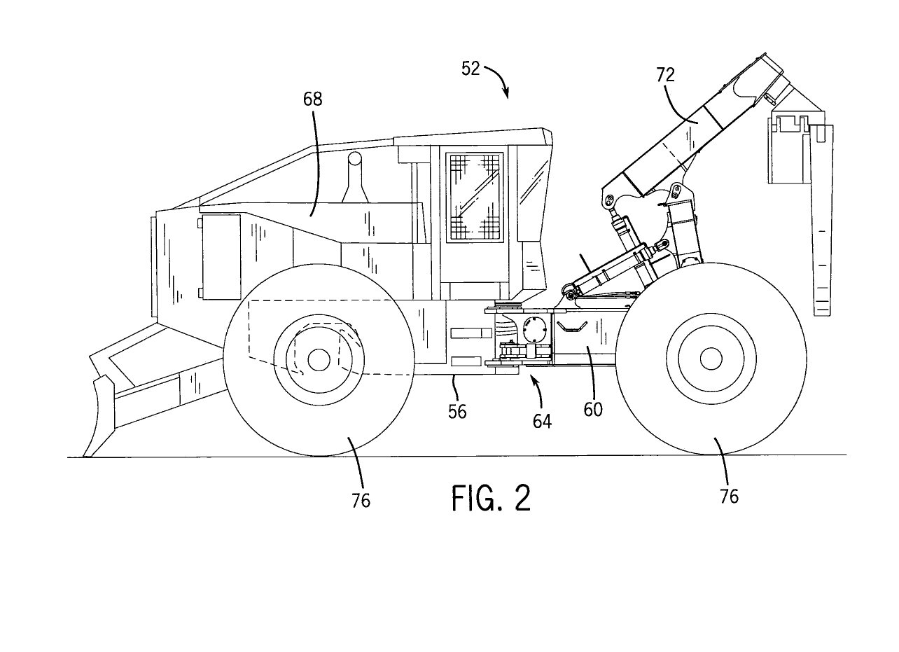

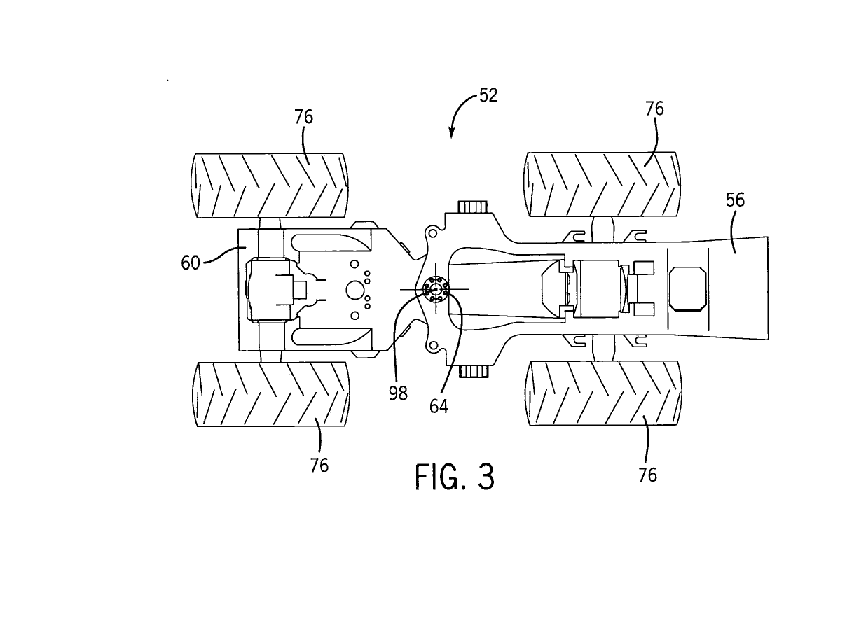

FIGS. 2 and 3 show an example work vehicle in the form of an articulated forestry vehicle 52, commonly called a “skidder”, that includes an articulated chassis formed by an engine frame 56 coupled to an equipment frame 60 by an example articulation joint 64. An engine 68 and other components are mounted to the engine frame 56, and a task specific implement 72, such as a boom-mounted grapple in the case of the illustrated skidder, is coupled to the equipment frame 60 and in communication with the engine 68. Four wheels 76 support the chassis of the forestry vehicle 52 and are coupled to drivetrain components driven by the engine 68 for movement over the ground. The articulation joint 64 would ordinarily be expected to provide for non-cyclical, low-speed, high-load relative rotation of the engine and equipment frames 56, 60 through approximately 90 degrees, such as approximately 45 degrees of movement to each side of the centerline of the vehicle chassis.

Those skilled in the art will readily understand the wide array of components that may be arranged on such work vehicles. Further, the articulation joint 64 may be implemented in work vehicles of other kinds, such as an earth mover, scraper, or other construction machinery. Depending on the specific arrangement of the work vehicle, the equipment frame 60 or the engine frame 56 may be arranged at the front or rear of the vehicle, as desired. Also, the vehicle may include more than four wheels 76, and may include other components or equipment, as desired.

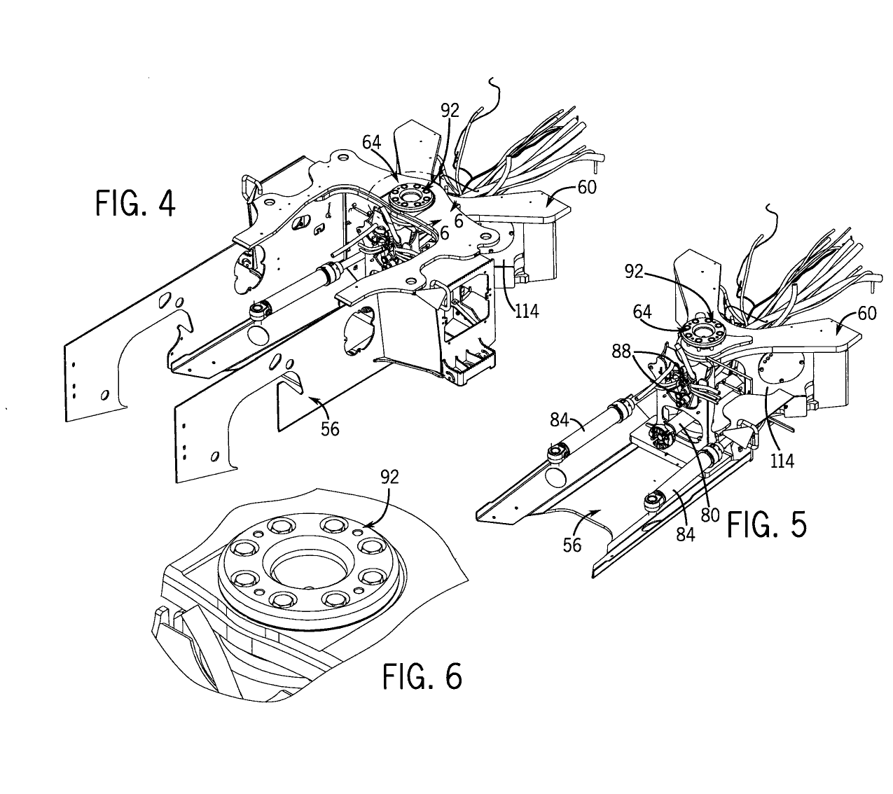

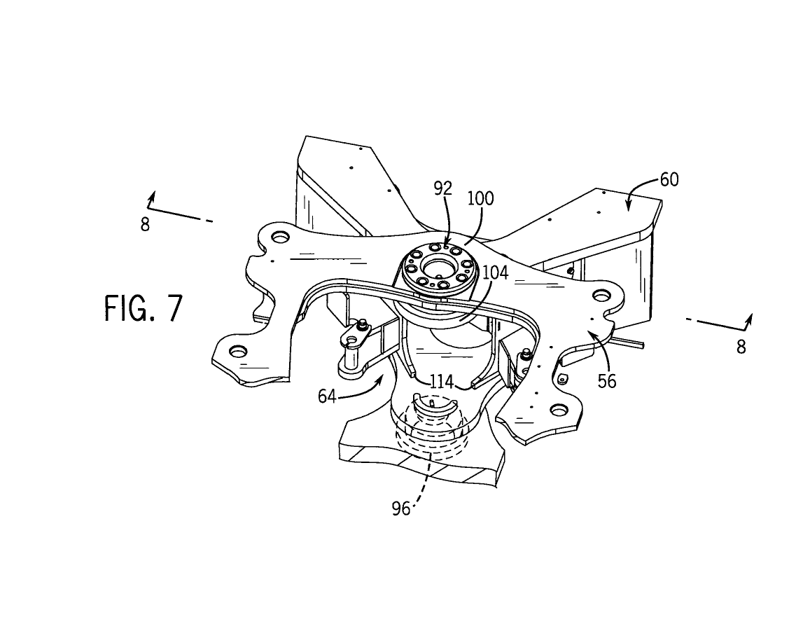

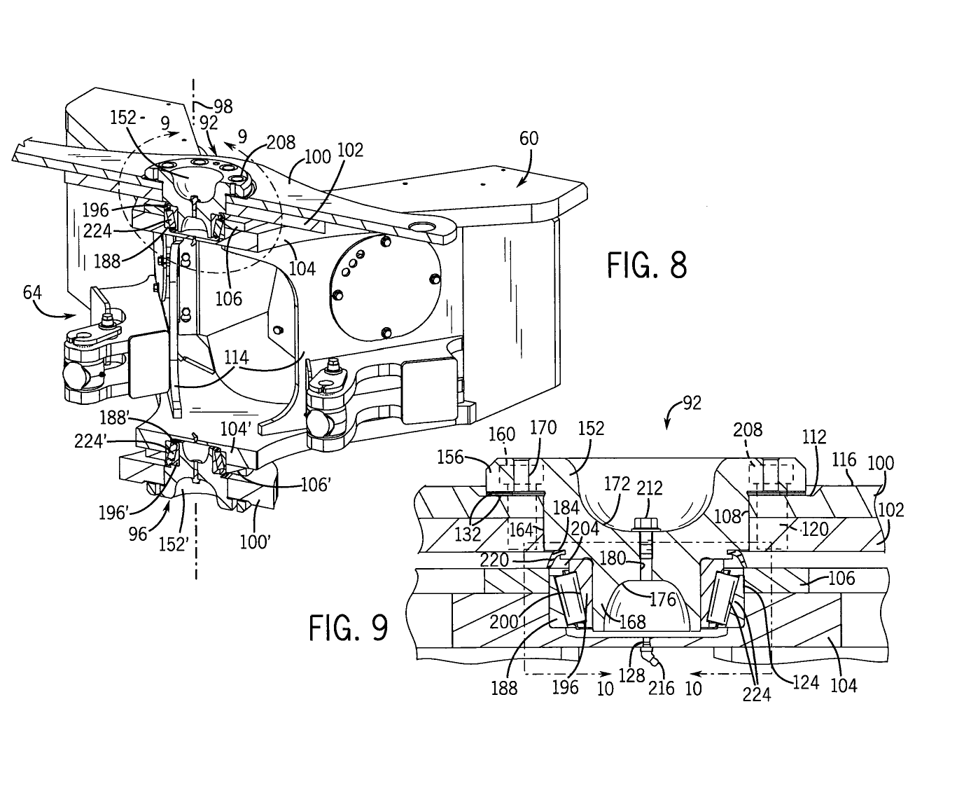

FIGS. 4 and 5 show the example articulation joint 64 with a drive shaft 80, actuators 84, hoses and wires 88, and other components passing therethrough. The articulation joint 64 includes an upper joint assembly 92 (shown in FIGS. 4-6) and a lower joint assembly 96 (see FIGS. 7 and 8). The upper and lower joint assemblies 92, 96 can be identical, but inverted, and arranged to be spaced apart along a main pivot axis 98 of the chassis (see FIGS. 3 and 8). Thus, the description of the joint assemblies 92, 96 will be made primarily with reference to the upper joint assembly 92 and a cursory description of the lower joint assembly 96 will be made thereafter.

Turning now to FIG. 9, the upper joint assembly 92 includes an engine frame lug 100, which can be a single tab-like structure in the form of an integral extension of the engine frame 56 and to which a spacer plate 102 is welded, and an equipment frame lug 104, which can also be a single tab-like integral extension of the equipment frame 60 and to which another spacer plate 106 is welded. In other constructions, the lugs 100, 104 may be bolted or welded to the respective frame 56, 60, either with or without the spacers plates 102, 106. The lugs 100, 104 are sized such that, under the predetermined preload of the joint assembly 92, as described below, the lugs 100, 104 resist bending and undergo only a very minimal deflection so as to maintain an essentially parallel alignment between the lugs 100,104 of the two frames 56, 60. To achieve this stiffness the lugs 100, 104 are made of sufficiently thick plate material and are supported by vertical gussets 114, which are themselves of sufficient thickness and rigidity. This joint stiffness further leads to a minimal axial or angular misalignment of the joint assembly 92.

The engine frame lug 100 defines an engine frame lug aperture 108 and a depression 112 formed in a top surface 116 thereof. A plurality of threaded apertures 120 are arranged about the engine frame lug aperture 108. The equipment frame lug 104 defines an equipment frame lug aperture 124 and a grease fitting aperture 128.

Positioned in the depression 112 is one or more shims 132. The shims 132 are shown in more detail in FIG. 11 and each includes a first half 136 and a second half 140. Each half has bolt cutouts 144 arranged to align with the threaded apertures 120 of the engine frame lug 100. The shims 132 also define jack screw cutouts 148 whose purpose will be described below.

Turning back to FIG. 9, a pin 152 includes an upper flange 156 arranged to engage an upper surface of the top shim 132 and including a plurality of countersunk apertures 160 arranged to align with the threaded apertures 120 of the engine frame lug 100. The pin 152 further includes a frame portion 164 with a diameter sized to be received within the engine frame lug aperture 108 via a tight slip fit, and a bearing portion 168. Threaded jack screw apertures 170 are formed in the flange 156 and are arranged to align with the jack screw cutouts 148 of the shim 132. A top depression 172 is formed in a top surface of the pin 152 and a bottom depression 176 is formed in a bottom surface of the pin 152 and a plug aperture 180 is formed therebetween. A seal groove 184 is formed in the pin 152 between the frame portion 164 and the bearing portion 168.

A bearing cup 188 defines an outer diameter sized to be received via an interference fit in the equipment frame lug aperture 124. The bearing cup 188 defines a cup raceway 192. A bearing cone 196 defines an inner diameter sized to be received on the bearing portion 168 of the pin 152 via interference fit. The bearing cone 196 defines a cone raceway 200 and a shoulder 204.

When assembled, the upper joint assembly 92 includes fasteners 208 that pass through the countersunk apertures 160 of the pin 152, the bolt cutouts 144 of the shims 132 and thread into the threaded apertures 120 of the engine frame lug 100 to securely hold the pin thereto. A plug 212 is threaded into the plug aperture 180, a grease fitting 216 is threaded into the grease fitting aperture 128, a grease seal 220, such as conventional urethane-based compliant seal, is installed in the seal groove 184, and a plurality of rollers 224 are arranged between the bearing cup 188 and the bearing cone 196. The illustrated rollers 224 are tapered pin type rollers and support the upper joint assembly 92 in both the axial and radial directions.

The lower joint assembly 96 is substantially identical to the upper joint assembly 92, however install in an inverted fashion relative to the upper joint assembly 92. Components of the lower joint assembly 96 have been labeled with prime numbers corresponding to the above description of the upper joint assembly 92.

The manufacture and assembly of the articulation joint 64 will now be described with further reference to FIG. 9. First, the frames 56, 60, and in particular the lugs 100, 104, can be machined to improve the accuracy and fit of the articulation joint 64. Machining these components aids in achieving a close and controlled fit of the components of the joint assemblies 92, 96 and thereby in reducing relative inclination of the lugs 100, 104 at the joint assemblies 92, 96 and possible damage to, or excessive wear of, the joint 64.

To assemble, the bearing cup 188 can be press fit into the blind equipment frame lug aperture 124. Temperature differential may be used to aid in effecting the press fit. For example, the bearing cup 188 may be cooled and the lug 104 may be heated prior to the press fit operation, although cooling the bearing cup 188 without also heating the lug 104 is also suitable. As an example, the bearing cup may be cooled to about negative 40 degrees Celsius and the lug 104 may be heated to about 120 degrees Celsius. Next, with the grease seal 220 mounted to the seal groove 184, the bearing cone 196 along with the rollers 224 are press fit onto the bearing portion 168 of the pin 152. Again a temperature differential may be utilized. Then, the pin 152 is installed through the engine frame lug aperture 108 with the shims 132 arranged between the depression 112 and the upper flange 156. The fasteners 208 are then tightened to a predetermined torque setting to maintain the pin 152 installed with the engine frame lug 100. With the pin 152 installed, the rollers 224 are engaged between the cup raceway 192 and the cone raceway 200 and maintained therebetween by the shoulder 204. The bearing cup 188, the bearing cone 196, and the rollers 224 together define a bearing assembly 228. The illustrated bearing assembly 228 is a single row tapered bearing assembly.

The bearings can be preloaded to a predetermined load rating. The preload can be selected to be the highest predicted load that each joint assembly 92, 96 is predicted to encounter. In one construction, the preload may be about 180 kilonewtons (180 kN). The preload reduces galling and other detriments to the joint assembly 92. The preload may be increased by decreasing the thickness or count of the shims 132 and may be decreased by increasing the thickness or count of the shims 132.

In the illustrated construction, each shim 132 includes a first half 136 and a second half 140 such that the shim 132 may be installed beneath the upper flange 156 of the pin 152 without full removal of the fasteners 208. To further aid in the adjustment of the shims 132 and the preload of the joint assembly 92, jack screws (not shown) may be threaded through the jack screw apertures 170 and into contact with the depression 112. With the fasteners 208 loosened, the jack screws may be used to manipulate the pin 152 away from the depression 112 thereby making room for the addition or removal of shims 132, should it be needed.

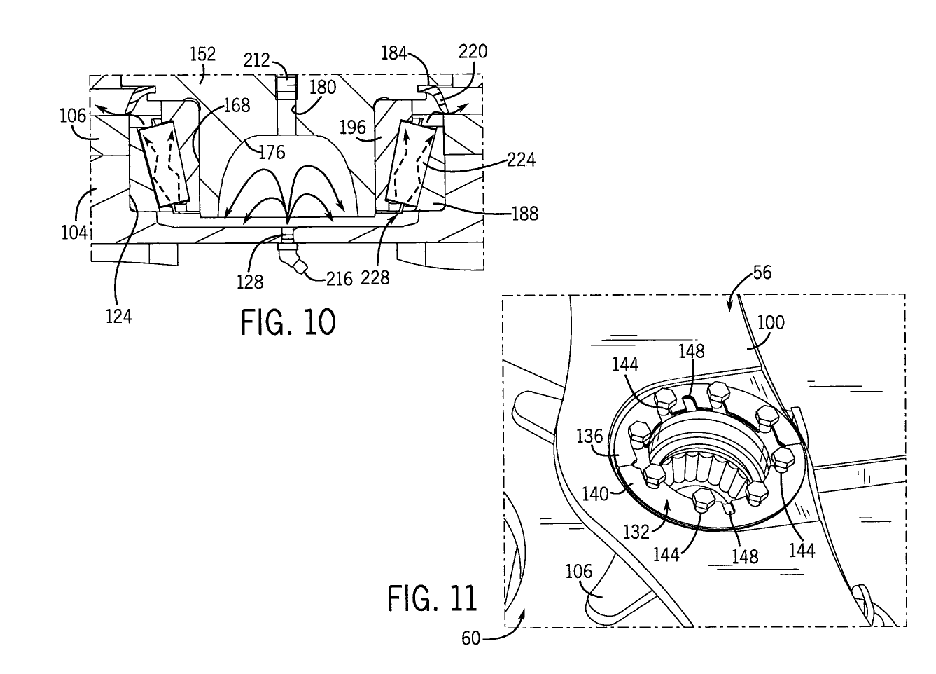

Finally, the plug 212 and the grease fitting 216 are installed. Then grease is pumped through the grease fitting and fills the bearing assembly 228 as shown in FIG. 10. The grease seal 220 maintains the grease within the bearing assembly 228 during use and inhibits contaminants from fouling the grease or bearing assembly.

As mentioned above, ground clearance and overall vehicle height are important considerations for large work vehicles of this type, such as the forestry vehicle 52 illustrated in FIG. 2. Such work vehicles typically operate off road and thus require high ground clearance. High ground clearance is particularly important for forestry machines, which typically drive over stumps and logs during operation. Limiting the overall height of the vehicle is also important in order to meet the over the road hauling maximum height regulations of various states or municipalities. It is also important to control the height of the chassis from the ground in order to balance the benefits of high ground clearance with the adverse affects on vehicle stability and operator access to the vehicle cabin that can arise if the chassis is elevated excessively. By way of example, work vehicles, such as the forestry vehicle 52 shown in FIG. 2, can require a minimum ground clearance of 2 feet (0.6 meters) and the total height of the vehicle 52 may be no larger than 11 feet (3.4 meters). In other words the upper bounds for the articulation joint 64 can be 5 feet (1.5 meters) and the minimum bounds can be 2 feet (0.6 meters).

As also mentioned, it is often desired to mount the interconnecting components that span the two chassis frames 56, 60 along the centerline of the vehicle chassis so as not to interfere with the articulation of the chassis or otherwise comprising such components when the vehicle articulates. Thus, the driveshaft 80, actuators 84, hoses and wires 88, and other components are desired to pass through the articulation joint 64. Therefore, it is desirable to maximize the space available within the bounds.

The inventive articulation joint 64 provides a relatively larger interior space when compared to the previously employed clevis-type connection. Clevis-type connections require a relatively large amount of space and a greater number of parts. Maximizing the space between the upper joint assembly 92 and the lower joint assembly 96 also minimizes the radial load rating required of the bearings. The greater the number of parts, often the greater the cost and complexity of the system.

Moreover, in prior art articulation joints, ground clearance has been reduced or components have been routed outside the articulation joint. The inventive articulation joint 64 provides an increased ground clearance while routing all system components through the center of the articulation joint 64 thereby protecting the components.

The above-described example articulation joint 64 can provide a work vehicle that meets the aforementioned overall height and ground clearance requirements while providing an increased volume of usable space within the articulation joint 64. By way of example, the forestry vehicle 52 shown in FIG. 6, can have a usable interior space with a vertical dimension of approximately 20 inches (50 centimeters).

The foregoing detailed description describes the subject of this disclosure in one or more examples. A skilled person in the art to which the subject matter of this disclosure pertains will recognize many alternatives, modifications and variations to the described example(s). For example, the above-described articulation joint 64 provides an example in which the articulation joint has no clevis-type connections, specifically at both the upper and lower joint assemblies the two frames of the chassis mate at single tab-like lugs, that is one lug from each frame at both the upper and lower sections of the joint. However, the articulation joint could be constructed with only one joint assembly being formed of by mating single lugs from each frame. In addition, the articulation joint 64 described is constructed with the two upper and lower lugs of the engine frame from being outside of, that is above and below, the lugs of the equipment frame. However, this could be reversed so that the equipment frame lugs are to the outside of the engine frame lugs.

Thus, the following claims should be referenced with regard to the scope of the invention.

What is claimed is:

1. An articulation joint for a work vehicle having a chassis including a first frame coupled to a second frame by the articulation joint, the first frame including a first lug and a second lug and the second frame including a first lug and a second lug, the articulation joint comprising:
a first joint assembly that includes a first bearing assembly coupled between the first frame first lug and the second frame first lug; and
a second joint assembly spaced along a pivot axis from the first joint assembly, the second joint assembly including a second bearing assembly coupled between the first frame second lug and the second frame second lug;
wherein the first frame first lug is positioned at a side of the first joint assembly opposite the second joint assembly and wherein a space within the articulation joint defined between the second frame first lug and the second joint assembly is uninterrupted by the first joint assembly.

2. The articulation joint of claim 1, wherein the first frame second lug is positioned at a side of the second joint assembly opposite the first joint assembly, and wherein a space within the articulation joint defined between the second frame second lug and the first joint assembly is uninterrupted by the second joint assembly.

3. The articulation joint of claim 1, wherein the first frame second lug is positioned at a side of the second joint assembly nearest the first joint assembly, and wherein a space within the articulation joint defined between the first frame second lug and the first joint assembly is uninterrupted by the second joint assembly.

4. The articulation joint of claim 1, wherein the first joint assembly further includes a first pin defining a first bearing portion, and wherein the second joint assembly further includes a second pin defining a second bearing portion.

5. The articulation joint of claim 4, wherein the first bearing assembly includes a first bearing cone engaged with the first bearing portion of the first pin and defining a first cone raceway, a first bearing cup coupled to the second frame first lug and defining a first cup raceway, and a plurality of first rollers arranged between the first cone raceway and the first cup raceway; and
wherein the second bearing assembly includes a second bearing cone engaged with the second bearing portion of the second pin and defining a second cone raceway, a second bearing cup coupled to the second frame second lug and defining a second cup raceway, and a plurality of second rollers arranged between the second cone raceway and the second cup raceway.

6. The articulation joint of claim 5, wherein the first lug of the first frame defines a first aperture receiving the first pin, and wherein the first lug of the second frame defines a second aperture receiving the second pin, and wherein the first lug of the second frame defines a first cup aperture receiving the first bearing cup, and wherein the second lug of the second frame defines a second cup aperture receiving the second bearing cup.

7. The articulation joint of claim 6, wherein the first bearing cone is press fit onto the first bearing portion of the first pin, and wherein the second bearing cone is press fit onto the second bearing portion of the second pin.

8. The articulation joint of claim 1, wherein the first joint assembly and the second joint assembly are preloaded.

9. The articulation joint of claim 8, wherein the first joint assembly further includes one or more shims located between the first bearing assembly and at least one of the first lugs of the first and second frames to affect the preloading.

10. An articulation joint for a work vehicle having a chassis including a first frame coupled to a second frame with the articulation joint, the first frame including a first frame lug with a first frame lug aperture and the second frame including a second frame lug with a second frame lug aperture, the articulation joint comprising:
a pin received in the first frame lug aperture and fastened to the first frame lug, the pin defining a bearing portion;
a bearing cone engaged with the bearing portion of the pin and defining a cone raceway;
a bearing cup received in the second frame lug aperture and defining a cup raceway; and
a plurality of rollers arranged between the cone raceway and the cup raceway;
wherein the pin extends into the second frame lug aperture but does not extend through the second frame lug aperture.

11. The articulation joint of claim 10, further comprising a shim positioned between a flange formed on the pin and the first frame lug, wherein a thickness of the shim determines, at least in part, a preloading of the articulation joint.

12. The articulation joint of claim 10, wherein the rollers are tapered pin rollers.

13. The articulation joint of claim 10, wherein the bearing cup is press fit into the second frame lug aperture.

14. The articulation joint of claim 10, wherein the bearing cone is press fit onto the bearing portion of the pin.

15. An articulated chassis work vehicle, comprising;
a first frame that defines an upper first frame lug with an upper first frame lug aperture, and a lower first frame lug with a lower first frame lug aperture;
a second frame that defines an upper second frame lug with an upper second frame lug aperture, and a lower second frame lug with a lower second frame lug aperture; and
an articulation joint rotationally coupling the first frame to the second frame and including:
an upper joint having an upper bearing assembly that includes:
an upper pin received in the upper first frame lug aperture and fastened to the upper first frame lug, the upper pin defining an upper bearing portion;
an upper bearing cone engaged with the upper bearing portion of the upper pin and defining an upper cone raceway;
an upper bearing cup received in the upper second frame lug aperture and defining an upper cup raceway;
a plurality of upper rollers arranged between the upper cone raceway and the upper cup raceway; and
a lower joint having a lower bearing assembly that includes:
a lower pin received in the lower first frame lug aperture and fastened to the lower first frame lug, the lower pin defining a lower bearing portion;
a lower bearing cone engaged with the lower bearing portion of the lower pin and defining a lower cone raceway;
a lower bearing cup received in the lower second frame lug aperture and defining a lower cup raceway; and
a plurality of lower rollers arranged between the lower cone raceway and the lower cup raceway.

16. The work vehicle of claim 15, wherein the upper first frame lug is at a side of the upper joint opposite the lower joint, and wherein a space within the articulation joint defined between the upper second frame lug and the lower joint is uninterrupted by the upper joint.

17. The articulation joint of claim 16, wherein the lower first frame lug is positioned at a side of the lower joint opposite the upper joint, and wherein a space within the articulation joint defined between the lower second frame lug and the upper joint is uninterrupted by the lower joint.

18. The articulation joint of claim 16, wherein the lower first frame lug is positioned at a side of the lower joint nearest the upper joint, and wherein a space within the articulation joint defined between the lower first frame lug and the upper joint is uninterrupted by the lower joint.

19. The work vehicle of claim 15, wherein the upper joint further includes an upper shim positioned between an upper flange formed on the upper pin and the upper first frame lug, and wherein the lower joint further includes a lower shim positioned between a lower flange formed on the lower pin and the lower first frame lug.

20. The work vehicle of claim 19, wherein the upper bearing cone is press fit onto the upper bearing portion of the upper pin and the lower bearing cone is press fit onto the lower bearing portion of the lower pin, and wherein the upper bearing cup is press fit into the upper second frame lug aperture, and wherein the lower bearing cup is press fit into the lower second frame lug aperture.
